(19) United States
(12) Patent Application Publication
(10) Pub. No.: US 2024/0100613 A1
(43) Pub. Date: Mar. 28, 2024

(54) ELECTRIC DISCHARGE MACHINING WIRE

(71) Applicant: Proterial, Ltd., Tokyo (JP)

(72) Inventors: Shingo AMEMIYA, Tokyo (JP); Hiroyoshi HIRUTA, Tokyo (JP); Hiromitsu KURODA, Tokyo (JP); Yosuke SHIBA, Tokyo (JP)

(21) Appl. No.: 18/446,052

(22) Filed: Aug. 8, 2023

(30) Foreign Application Priority Data
Sep. 22, 2022 (JP) 2022-150978

(51) Int. Cl. B23H 1/06

(52) U.S. Cl. CPC B23H 1/06

(57) ABSTRACT

An electric discharge machining wire includes a brass containing 43 mass % or less of zinc (Zn) and having an α-phase and a ρ-phase, wherein a component ratio of the α-phase in the brass is greater than 50 vol % and 55 vol % or less.

### CROSS-REFERENCE TO RELATED APPLICATIONS

The present patent application claims the priority of Japanese patent application No. 2022-150978 filed on Sep. 22, 2022, and the entire contents thereof are hereby incorporated by reference.

### TECHNICAL FIELD

The present invention relates to an electric discharge machining wire (EDM wire), i.e., an electrode wire for wire electric discharge machining.

### BACKGROUND OF THE INVENTION

Conventionally, electric discharge machining wires made of brass are known (see Patent Literature 1). The electric discharge machining wire described by Patent Literature 1 is composed of brass containing 41 to 60% by weight (wt %) of zinc (Zn), and its composition is in the region of mainly β-phase, and it is described that this composition improves the properties of the brass wire, enabling increased strength, improved electrical discharge characteristics, and improved wire-drawing workability.

Citation List Patent Literature 1: JPH9-11048A

### SUMMARY OF THE INVENTION

However, since the properties of an electric discharge machining wire composed of brass vary depending on a Zn content, the Zn content and the ratio of the intermetallic compound phase that varies depending on the Zn content must be optimized according to the properties required for the desired machining.

Therefore, the object of the present invention is to provide an electric discharge machining wire that can achieve both machining speed and surface accuracy of the workpiece in wire electrical discharge machining.

For the purpose of solving the aforementioned problem, one aspect of the present invention provides an electric discharge machining wire, comprising a brass containing 43 mass % or less of zinc (Zn) and having an a-phase and a β-phase, wherein a component ratio of the α-phase in the brass is greater than 50 vol % and 55 vol % or less.

### Advantageous Effects of the Invention

According to the present invention, it is possible to provide an electric discharge machining wire that can achieve both machining speed and surface accuracy of the workpiece in in wire electrical discharge machining.

### BRIEF DESCRIPTION OF DRAWINGS

FIG. 1 is a schematic diagram showing how a flat plate-like workpiece is processed by wire electric discharge machining.

FIGS. 2A to 2C are microscopic images of a cross-section of an electric discharge machining wire in an Example.

FIGS. 3A to 3C are microscopic images of a cross-section of an electric discharge machining wire in a comparative example.

FIG. 4 is a diagram of a rectangular parallelepiped sample piece cut out for the electric discharge evaluation.

### DETAILED DESCRIPTION OF THE INVENTION

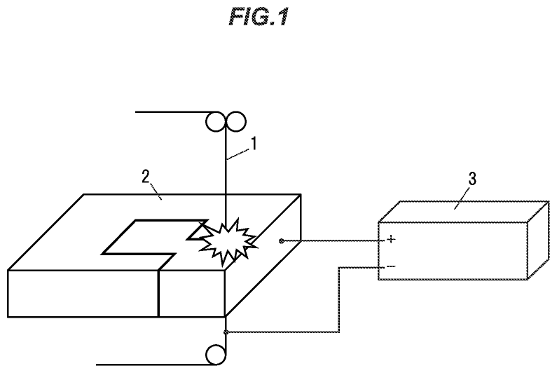

FIG. 1 is a schematic diagram showing how a flat plate-like workpiece is processed by wire electric discharge machining. In wire electric discharge machining, as shown in FIG. 1, a pulse voltage is applied between an electric discharge machining wire 1 and a workpiece (i.e., machining target) 2 made of metal material by a machining power supply 3 to generate electric discharge between the electric discharge machining wire 1 and the workpiece 2 made of metal material. The electric discharge machining wire 1 is moved like a thread saw while being wound, and two-dimensional machining is performed on the workpiece 2 in a pre-programmed shape.

### Configuration of the Electric Discharge Machining Wire

The electric discharge machining wire 1 is composed of brass containing 43 mass % (mass percent) or less of zinc (Zn) and having an α-phase and a β-phase, wherein a component ratio of the a-phase in the brass is 50 vol % (volume percent) or more and 55 vol % or less. The components other than the α-phase of the brass constituting the electric discharge machining wire 1 are almost all β-phase.

Brass is a copper alloy containing zinc, and the intermetallic phase changes depending on the zinc content rate. When the zinc content rate is low, the α-phase is dominant, but when the zinc content rate exceeds 40 mass %, the component ratio of the α-phase decreases rapidly, and the α-phase almost disappears above 45 mass % of the zinc content rate. Up to 45 mass % of the zinc content rate, the α-phase and the β-phase coexist, and the electric discharge machining wire 1 with the zinc content rate of 43 mass % or less has the α-phase and the β-phase. The zinc content rate of the electric discharge machining wire 1 is set at 43 mass % or less in order to make the component ratio of the α-phase greater than 50 vol %.

The surface accuracy of the workpiece 2 is affected by the dimensional accuracy and surface smoothness of the electric discharge machining wire 1, but it is also affected by the material. In order to facilitate the generation of discharge sparks between the workpiece 2 and the electric discharge machining wire 1 and to improve the surface accuracy of the workpiece 2, the zinc content rate of the electric discharge machining wire 1 is preferably greater than 40 mass %, and more preferably 42 mass % or more.

When the component ratio of the α-phase is greater than 50 vol %, the electric discharge machining wire 1 is less likely to crack during wire-drawing, resulting in less frequent wire breakage (disconnection). When the component ratio of the α-phase is greater than 50 vol % and 55 vol % or less, the surface roughness of the workpiece 2 is less varied in each direction. Therefore, it is preferable that the component ratio of the α-phase of the brass constituting the electric discharge machining wire 1 be greater than 50 vol % and 55 vol % or less. In particular, the electric discharge machining wire 1 has a zinc content rate of 42 mass % or more and 43 mass % or less, and the component ratio of the α-phase of the brass constituting the electric discharge machining wire 1 is greater than 50 vol % and not higher than 55 vol %, thereby improving the electric discharge machining performance compared to electric discharge machining wire in which the zinc content rate is 40 mass % or less. The electrode wire can improve both the surface accuracy and the machining speed when machining a workpiece 2 that is 20 mm or more and 100 mm or less in thickness, because the discharge performance can be improved compared to that of an electric discharge machining wire that has a zinc content rate of 40 mass % or less.

Although the surface accuracy of the workpiece 2 can be improved by increasing the number of machining cycles, the more the number of cycles increases, the more the machining time and the consumption of the electric discharge machining wire 1 increases, resulting in higher costs. According to the electric discharge machining wire 1, the surface accuracy of the workpiece 2 can be improved without increasing the number of times of machining. In some cases, polishing is applied to the machined surface of the workpiece 2 to obtain a mirror surface after electric discharge machining, but using the electric discharge machining wire 1, the surface accuracy of the workpiece 2 can be increased, which may reduce the work time for the polishing process, which is an additional process.

The outer diameter of the electric discharge machining wire 1 is, e.g., 0.10 mm or more and 0.45 mm or less. The tensile strength (TS) of the electric discharge machining wire 1 is more than 900 MPa and less than or equal to 1500 MPa, and the elongation (EL) is, e.g., 0.4% or more and 10.0% or less when the outer diameter is within the above range.

Here, the measurement of tensile strength (TS) of the electric discharge machining wire 1 was performed using the RTC-1150A universal material testing machine manufactured by Orientec Corporation as the measuring device, according to the following procedure: (1) First, an electric discharge machining wire 1 of a predetermined length is prepared as a sample. (2) Both ends of the sample are fixed to the measuring device and the sample is held in a straight line. (3) Then, one end of the sample is pulled at a constant speed of 50 mm/min. (4) A maximum load when the sample breaks is measured (load range: 100N). (5) The breaking load is divided by the cross-sectional area of the sample to calculate the tensile strength.

The measurement of elongation (EL) of the electric discharge machining wire 1 was performed using the same measuring device used for the measurement of tensile strength (TS) and the same procedure as (1) through (3) above. The length between the points when the sample breaks is measured, and the elongation is calculated by the formula “EL=100*(L−L₀)/L₀”, where L is the length between the points when the sample breaks, and L₀ is the length between the points before the sample is pulled.

### Manufacturing Method of an Electric Discharge Machining Wire

As an example of a manufacturing method for the electric discharge machining wire 1, a manufacturing method for an electric discharge machining wire with an outer diameter of 0.25 mm is shown below.

First, a brass wire before drawing with an outer diameter of 0.90 mm is passed through a drawing die provided in a wire-drawing machine and drawn at a predetermined speed (e.g., 1000 m/min or more). At this time, the brass wire is annealed after the drawing process using an annealer to remove the strain accumulated in the brass wire by the drawing process. For annealing to remove the strain, the brass wire after the drawing process is annealed under heating conditions that do not change the component ratio of the α-phase of the brass wire after the drawing process (e.g., in a short time of a few seconds). Then, after the drawing process, the brass wire with an outer diameter of 0.25 mm as the electric discharge machining wire 1 is wound onto a drum. The component ratio of the α-phase can be controlled by changing the manufacturing conditions (e.g., cooling rate during casting) when obtaining the brass wire before drawing.

### Evaluation of the Electric Discharge Machining Wire

As an example of the electric discharge machining wire 1, an electrode wire made by the manufacturing method described above and comprising brass with a zinc content rate of 42.2 mass % (copper content rate of 57.8 mass %) and an α-phase component ratio of 51 vol % was prepared and evaluation. As a comparative example, an electrode wire with a zinc content rate of 42.44 mass % (copper content rate of 57.56 mass %) and an α-phase component ratio of 47 vol % was prepared and evaluated. The comparative example is HBZ-B wire manufactured by Hitachi Metals, Ltd., and has superior surface accuracy and machining accuracy compared to general-purpose electric discharge machining wires.

The component ratios of the α-phase in the electrode wires in the Example and the comparative example were determined by observing the entire cross-section of the brass wires with an outer diameter of 0.90 mm as the base material, respectively. The component ratios of the α-phase and the β-phase in the electrode wires do not change due to annealing performed after drawing the brass wires, which were the base metal of the electrode wire, or by drawing the brass wires. Therefore, it can be said that the a-component ratios of the electrode wires in the Example and the comparative example were equal to the α-component ratios of the respective brass wires as the base material, and were 51 vol % and 47 vol %, respectively.

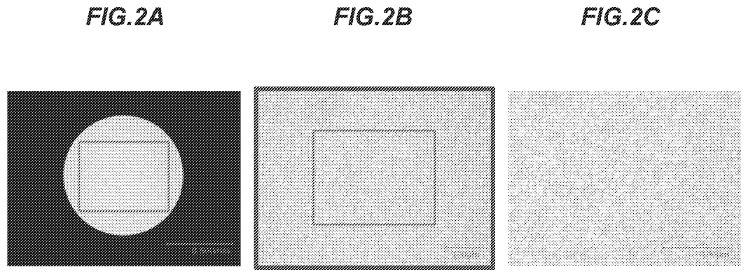

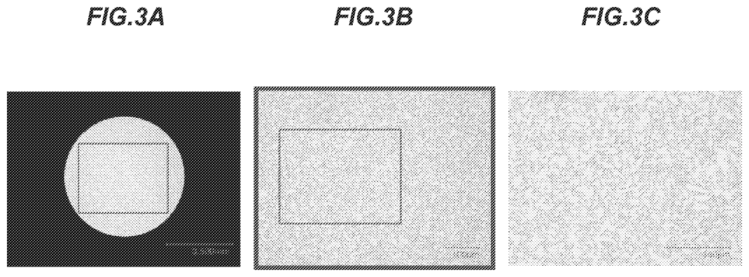

FIGS. 2A and 3A are microscopic images of the cross-sections of the brass wires that are the base materials of the electrode wires in the Example and the comparative example, respectively. The entire cross-sections of the brass wires are subjected to ion milling treatment to observe the metallographic structure. FIGS. 2B and 3B are enlarged images of the area including the center of the electrode wire surrounded by squares in FIGS. 2A and 3A, respectively. FIGS. 2C and 3C are enlarged images of the area surrounded by squares in FIGS. 2B and 3B, respectively.

The darker colored areas in FIGS. 2C and 3C are the α-phase and the lighter colored areas are the β-phase. The images in FIGS. 2C and 3C were binarized, and the component ratio of α-phase was calculated by automatically measuring the area ratio of the α-phase portions, and it was confirmed that the component ratio of α-phase in the brass wire of the example and that of the comparative example were 51 vol % and 47 vol %, respectively. The component ratio of the α-phase of the brass wire (i.e., the component ratio of the α-phase of the electrode wire) was obtained by observing the entire cross-sections of the brass wires shown in FIGS. 2A and 3A using this calculation method.

Next, electric discharge machining evaluations were conducted using electrode wires each with an outer diameter of 0.25 mm in the Example and comparative example, respectively.

In this electric discharge machining evaluation, sample pieces 20 with a flat shape of 10×10 mm were cut out by electric discharge machining from a flat plate-like material of 20 mm thickness made of SKD-11 as workpiece 2, using the Robocut α-0iE manufactured by Fanuc Corporation as a wire electric discharge machining machine. The number of machining cycles was 3 and machining was performed under standard conditions from the first cut to the third cut.

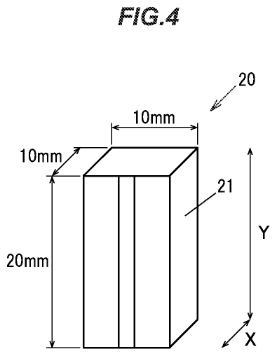

FIG. 4 is a diagram of the rectangular parallelepiped sample piece 20 cut out in the electric discharge machining evaluation. The X-direction shown in FIG. 4 is parallel to the plane direction of the workpiece 2, i.e., perpendicular to the wire feed direction, and the Y-direction is parallel to the thickness direction of the workpiece 2, i.e., parallel to the wire feed direction. Here, the wire feed direction is the direction in which the electrode wire (wire) is fed by the wire electric discharge machining machine in wire electric discharge machining.

The surface roughness Ra (arithmetic mean roughness), Rmax (maximum height), and Rz (ten-point mean roughness) were measured on the machined surface 21 of the sample piece 20 cut out using the electrode wires in the Example and the comparative example, respectively. Here, a machined surface 21 of the sample piece 20 is a surface along the Y-direction and parallel to the thickness direction of the workpiece 2.

The surface roughness Ra, Rmax, and Rz were measured using a surface roughness measuring machine SE-3H manufactured by Kosaka Laboratory Co. (1) The workpiece 2 is placed on the above surface roughness measuring machine. (2) The stylus is lowered to contact the workpiece 2. (3) The stylus scans three times along the X- and Y-directions on the surface of the workpiece 2, respectively. The length of the scanning of the stylus was 5 mm.

The average of each of the three Ra measurements, three Rmax measurements, and three Rz measurements obtained by the measurement in the X-direction was taken as the Ra, Rmax, and Rz in the X-direction. Similarly, the average of each of the three Ra measurements, the three Rmax measurements, and the three Rz measurements obtained by the measurement in the Y-direction was defined as Ra, Rmax, and Rz in the Y-direction.

The following Table 1 shows the machining speeds obtained in the electric discharge machining evaluation using the electrode wires in the Example and comparative example, as well as the values of Ra, Rmax, and Rz in the X- and Y-directions for the machined surface 21 of the sample piece 20.

TABLE 1

| | | | | Comparative |
|---|---|---|---|---|
| | | | Example | example |
| Machining speed | | | 6.52 mm/min | 6.56 mm/min |
| Surface | Ra | X-direction | 0.36 μm | 0.36 μm |
| roughness | | Y-direction | 0.37 μm | 0.43 μm |
| | Rmax | X-direction | 3.54 μm | 3.54 μm |
| | | Y-direction | 4.00 μm | 6.54 μm |
| | Rz | X-direction | 2.79 μm | 2.79 μm |
| | | Y-direction | 2.92 μm | 4.33 μm |

Table 1 shows that the difference between Ra in the X- and Y-directions is 0.07 μm in the comparative example, whereas the difference between Ra in the X- and Y-directions is 0.01 μm in the Example. The difference of Rmax between the X- and Y-directions in the comparative example was 3.00 μm, whereas the difference of Rmax between the X- and Y-directions in the example was 0.46 μm. The difference between Rz in the X- and Y-directions was 1.54 μm in the comparative example, whereas the difference between Rz in the X- and Y-directions was 0.13 μm in the Example.

As shown above, the difference between the values of Ra, Rmax, and Rz in the X-and Y-directions was smaller in the Example than in the comparative example, and it was confirmed that the variation of surface roughness in each direction was suppressed. This is assumed to be due to the difference in the component ratio of the α-phase between the electrode wires of the Example and those of the comparative example. In other words, it is considered that in the electrode wire according to the Example, the component ratio of the α-phase was greater than 50 vol % and 55 vol % or less, which means that the machined surface 21 of the sample piece 20 is machined with fine discharge sparks.

As for the machining speed, as shown in Table 1, there was no significant difference between the Example and the comparative example. In other words, it was confirmed that the electrode wire according to the Example improved the surface accuracy of the workpiece while maintaining the machining speed, compared to the electrode wire according to the comparative example, which was excellent in surface accuracy and machining accuracy.

The above results also show that when the electric discharge machining wire 1, composed of brass containing greater than 40 mass % and 43 mass % or less of zinc (Zn) and having an α-phase and a β-phase, in which the component ratio of the α-phase in the brass is greater than 50 vol % and 55 vol % or less, is used to process the workpiece 2, which is made of SKD-11, a surface accuracy within the difference of Ra between the X-and Y-directions of 0.02 μm can be expected to be obtained.

When the elongation (EL) of the electrode wire in the example and that in the comparative example were measured by the method described above, the elongation (EL) of the electrode wire in the example was 2.6% and that in the comparative example was 1.8%.

### Effects of the Embodiment

According to the above embodiment of the present invention, by using the electric discharge machining wire 1, which is composed of brass contains 43 mass % or less of zinc (Zn) and having an α-phase and a β-phase, and in which the component ratio of the α-phase in the brass is greater than 50 vol % and 55 vol % or less, the machining speed and the surface accuracy of the workpiece in wire electric discharge machining can be achieved.

### Summary of the Embodiment

Next, the technical concepts that can be grasped from the above described embodiment will be described with the help of the characters, etc. in the embodiments. However, each character, etc. in the following description is not limited to the members, etc. specifically shown in the embodiment as the components in the scope of claims.

According to the first feature, an electric discharge machining wire, comprising a brass containing 43 mass % or less of zinc (Zn) and having an α-phase and a β-phase, wherein a component ratio of the α-phase in the brass is greater than 50 vol % and 55 vol % or less.

According to the second feature, in the electric discharge machining wire 1 as described in the first feature, an elongation (EL) when an outer diameter is 0.25 mm is 2.0% or more.

According to the third feature, in the electric discharge machining wire 1 as described in the first feature, zinc contained in brass is 42 mass % or more.

In the above description, the embodiment of the present invention has been explained. However, the present invention is not limited to the above embodiment, and various modifications can be made without departing from the scope and spirit of the invention. Also, the embodiment does not limit the invention according to the scope of claims. Additionally, it should be noted that not all combinations of features are essential to the means for solving problems of the invention.

1. An electric discharge machining wire, comprising:
a brass containing 43 mass % or less of zinc (Zn) and having an α-phase and a β-phase, wherein a component ratio of the α-phase in the brass is greater than 50 vol % and 55 vol % or less.

2. The electric discharge machining wire, according to claim 1, wherein an elongation (EL) when an outer diameter is 0.25 mm is 2.0% or more.

3. The electric discharge machining wire, according to claim 1, wherein zinc contained in brass is 42 mass % or more.
